(19) United States
(12) Patent Application Publication
(10) Pub. No.: US 2008/0029991 A1
(43) Pub. Date: Feb. 7, 2008

(54) Hand-powered riding device

(76) Inventor: Shan Su, Sanmenxia (CN)

Correspondence Address: ACT INTERNATIONAL CORPORATION, PO BOX 722562, SAN DIEGO, CA, 92172, US

(21) Appl. No.: 11/804,852

(22) Filed: May 21, 2007

Related U.S. Application Data
(60) Provisional application No. 60/802,805, filed on May 23, 2006.

(51) Int. Cl. B62M 1/14

(52) U.S. Cl. 280/243

(57) ABSTRACT

A hand-powered riding device, in particular a self-propelled, wheeled riding device having a platform, a pulling rope and a pulley, is provided. The user, sitting or standing on the platform, pulls up the pulling rope wound around the pulley to cause the riding device to propel, simultaneously providing beneficial upper body exercise. The size of the said riding device is small, lightweight and portable.

This application claims the benefit of U.S. Provisional Application No. 60/802,805, filed May 23, 2006, the disclosure of which is incorporated herein by reference in its entirety.

### FIELD OF THE INVENTION

The present invention relates generally to self-propelled wheeled riding devices, more particularly, to small wheeled riding devices that are powered by hands.

### BACKGROUND OF THE INVENTION

At present, most mini-type conventional self-propelled wheeled riding devices are driven by leg kicking to maintain the wheels rotating, but the efficient distance and speed are limited. And it is hard for the user's upper body to remain effective exercising, and the whole body of some said riding devices are big and heavy, not easily portable.

In order to cover said shortness, the present invention is designed to make use of the user's hand pulling power—while sitting or standing on the platform—to cause the riding device go forward. It is desirable to bring the satisfaction of outdoor enjoyment, and also to strengthen the user's upper body while operating the riding device. It is light-weight and portable.

### SUMMARY OF THE INVENTION

The present invention is comprising:
A platform,
a caster device assembly installed in the front bottom of the platform,

A caster device assembly is composed of a caster frame, the front axle and two front wheels. The front axle is fixed with the caster frame, the front wheels are equipped separately on the both side of the front axle,
at least two rear wheel assemblies and its rotating axle fixed to the bearing housing, which is attached to the back bottom of the platform,

Each rear wheel shares one same axle with one overrunning clutch assembly and at least two fixed and interconnected belt pulleys. The positive wheel of the overrunning clutch assembly is attached to the adjacent rear wheel and fixed on the said axle. The drive wheel of the overrunning clutch assembly is attached and fixed to two adjacent belt pulleys, rotating coordinately on the axle.

The overrunning clutch assembly can be ratchet clutch or roller clutch.

Each side of the pulling rope and the elastic rope are connected separately with the grooves of two belt pulleys.

One side of the pulling ropes wind around the groove of the belt pulleys with the proper direction, the other side extends through the groove of pulley wheels attached to the rope holes and then connects with two handles separately. A bushing is fixed on the pulling rope above the rope hole. One side of the elastic ropes are fixed on the platform under the tense condition. The winding direction of two pulling ropes should be identical, and should also be as the same as the rotating direction of two overrunning clutch assemblies
a riser pad installed between the bearing housing and the platform,
an optional brake device assembly fixed near a rear wheel.

The optional brake device assembly is set up in the front of one rear wheel, including a curved brake pad, a shaft fixed under the platform, a brake lever that passes through the perforated platform a brake reverse spring. The middle of the brake pad attached to the shaft, one side of the brake pad is at the back of the shaft, the other side of the brake pad is at the front of the shaft, attached to the brake lever. Both sides of the brake reverse spring are fixed separately to the platform and the brake pad.

The user, sitting or standing on the platform, pulls up two handles connected with the pulling ropes, causing the drive wheels of the overrunning clutch assemblies to rotate, thus in turn causing the interconnected elastic ropes to wind automatically around the grooves of the belt pulleys, thus causing the positive wheels and the interconnected rear wheels and rear axle to rotate at the same time. When pulling movements cease, the drive wheels of the clutch assemblies will automatically rotate vibration, reset by the reaction of the elastic force from the elastic ropes, waiting for the next rope pull. By repeating the rope pulling movement, the user will cause riding device to move forward.

When the user steps down on the brake pad, it causes the front side of the brake pad to sway down, forcing the brake pad to rotate around the shaft. Thus, the rear side of the brake pad sways back against the rear wheel producing the frictional resistance to force the rear wheel, the shaft attached to it, and the other rear wheel, to stop rotating, causing the device to stop moving.

### BRIEF DESCRIPTION OF THE DRAWINGS

FIG. 1 is an exploded view to show the present invention, the partial is sectional view

FIG. 2 is an A view of the partial assemblies in FIG. 1, the partial is sectional view.

FIG, 3 is an A view of platform, bearing housing and riser pad assembly in FIG. 1,

FIG. 4 is an A view of the optional brake device assembly in FIG. 1.

FIG. 5 is a B view of the optional brake device assembly in FIG. 1.

FIG. 6 is a left view of the caster device assembly in FIG. 1.

FIG. 7 is a back view of FIG 1.

### DETAILED DESCRIPTION

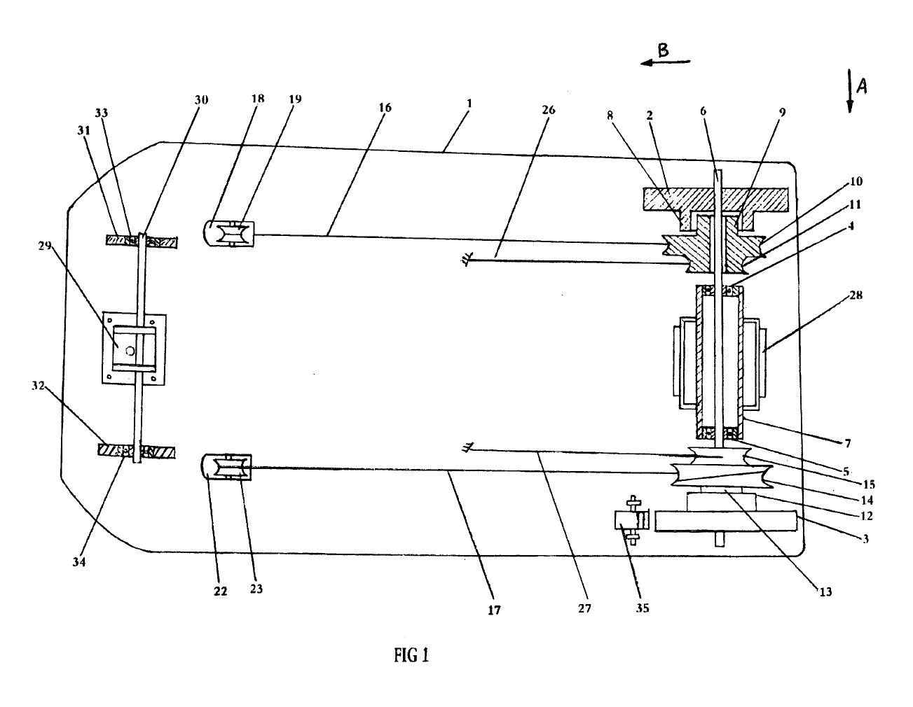

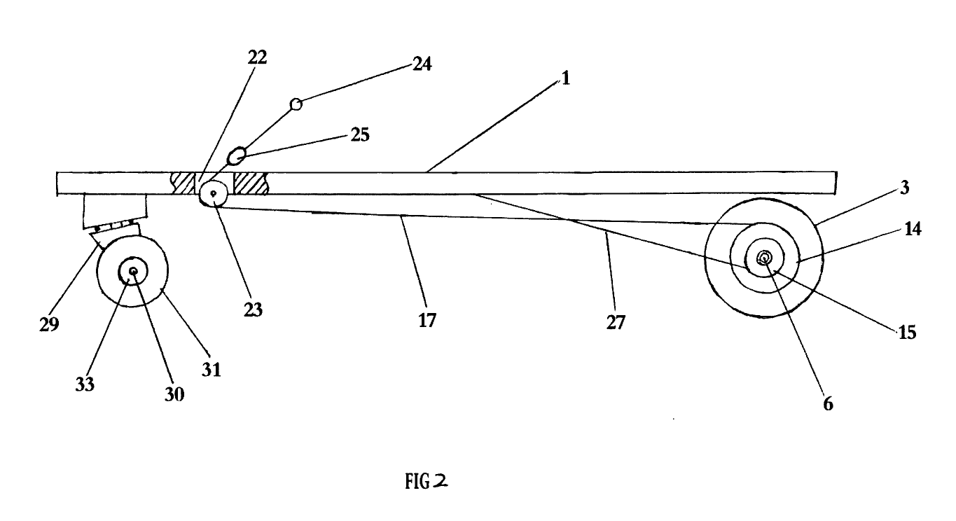

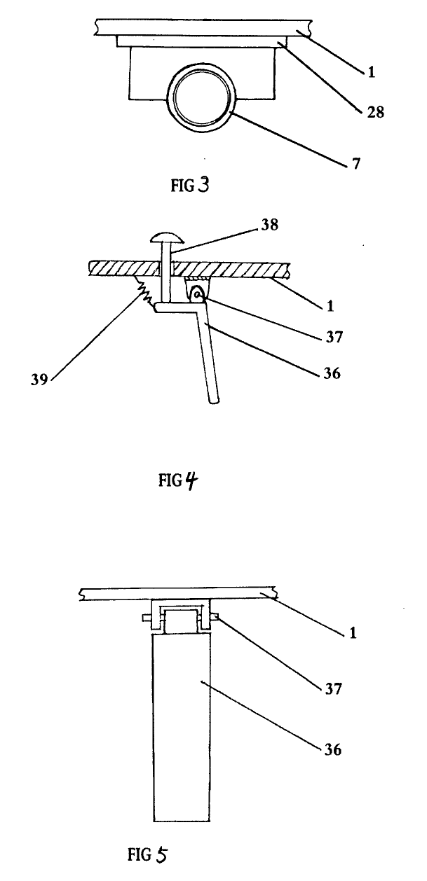

Referring to FIGS. 1-3, 7, the present invention is comprising:

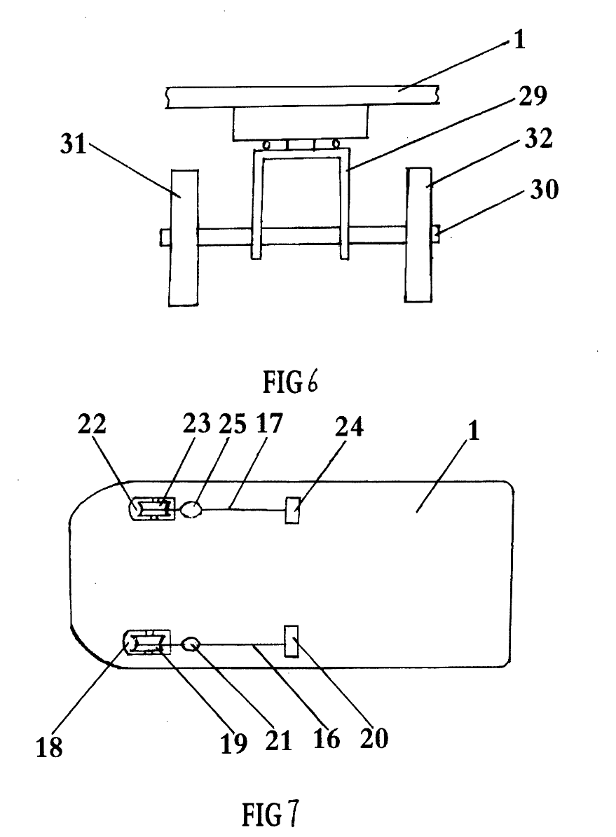

A platform 1, a caster device assembly FIG. 6 fixed in the front bottom of the platform, at least two rear wheels 2,3 assemblies are equipped with the bearings 4,5 on the rear axle 6, which is installed with the bearing housing 7 fixed to the rear bottom of the platform.

There is a riser pad 28 set up between the bearing housing 7 and the platform 1. The positive wheel 8 of the overrunning clutch assembly is attached to the adjacent rear wheel 2 and fixed to the rear axle 6. The drive wheel 9 of the overrunning clutch assembly is attached to two adjacent belt pulleys 10,11 and equipped on the rear axle 6. Present now, the overrunning clutch assemblies used for present invention are ratchet clutches, of which the other detailed parts are not shown.

Each side of the two pulling ropes 16,17 is wound separately around the grooves of the two belt pulleys 10,14. The winding direction of the two pulling ropes should be identical, and should be as same as the rotating direction of the two overrunning clutches. The other side of the pulling rope 16 extends through the groove of pulley wheel 19 attached to the rope hole 18 connecting with the handle 20. A bushing 21 is set on the pulling rope 16 above the rope hole 18. The other side of the pulling rope 17 extends through the groove of pulley wheel 23 attached to the rope hole 22 connecting with the handle 24. A bushing 25 is set on the pulling rope 17 above the rope hole 22.

One side of the elastic ropes 26,27 is wound separately around the belt pulleys 11,15, the other side of the elastic ropes 26,27 are fixed separately on the bottom of the base board, each elastic ropes remain the tense condition. The fixed points correspond to the direction of the grooves winded by the elastic ropes.

Referring to FIG. 6, The caster device assembly is composed of the caster frame 29, front axle 30 and two front wheels 31,32, The front axle 30 is fixed with the caster frame 29, the front wheels are equipped separately with bearing 33,34 on both sides of the front axle 30.

The user, sitting or standing on the platform 1, pulls up the handle 24 connected with the pulling rope 17, causing the drive wheel 13 of the overrunning clutch assembly to rotate, thus causing the interconnected elastic rope 27 to wind automatically around the groove of the belt pulley 18, thus coordinately bring the positive wheel 12 and two rear wheels 3,2, equipped on the same rear axle rotate at the same time, thus drive the riding device with the user standing or sitting on go forward. When pulling movements cease, the drive wheel 13 of the clutch assembly will automatically rotate vibration, reset by the reaction of the elastic force from the elastic rope 27, waiting for the next driven. When pulling up the other handle 20, it will bring the positive wheel 8 and two rear wheels rotate driving the riding device go forward. When pulling movements cease at the same reason, the drive wheel 9 of the clutch assembly will automatically rotate vibration, reset, waiting for the next driven. Repeat doing so, driving the riding device move forward.

Referring to FlG. 4-5, the optional brake device 35 assembly is set up in the front of the rear wheel 3, including a curved brake pad 36, a shaft 37 fixed under the platform, the brake lever 38 that passes through the perforated platform, the brake reverse spring 39. The middle part of the brake pad 36 movably attached to the shaft 37, one side of the brake pad 36 is at the rear of the shaft 37, the other side of the shaft 36 is at the front of the shaft 37, attached to the brake lever. Both sides of the brake reverse spring are connected separately with the platform 1 and the brake pad 36.

When the user steps down on the brake lever 38, it causes the front side of the brake pad 36 to sway down, forcing the brake pad 36 to rotate round the shaft 37, thus the rear side of the brake pad 36 sways back to touch the rear wheel 3 to produce the frictional resistance to force the rear wheel 3, the shaft 6 attached to, and the other rear wheel 2 stop rotating, causing the device to stop moving.

1. A hand-pulled, self-propelled riding device, comprising:
A platform, a caster assembly attached to a front bottom of said platform, at least two rear wheels and its rotating axle fixed to the bearing housing, each said rear wheel and a overrunning clutch assembly and at least two fixed interconnected belt pulleys share a same rotating axle, the positive wheel of the overrunning clutch assembly is attached to the adjacent rear wheel and fixed on the said axle, the drive wheel of the overrunning clutch assembly is attached and fixed to two adjacent belt pulleys, rotating coordinately on the axle, each side of the pulling rope and the elastic rope is connected separately with the grooves of two belt pulleys, a riser pad set up between the bearing housing and the platform, a brake device assembly is installed near a rear wheel.

2. The riding device of claim 1, wherein one side of the pulling ropes wind around the groove of the belt pulleys with the proper direction, the other side extends through the groove of pulley wheels attached to the rope holes and then connects with two handles separately, a bushing is fixed on the pulling rope above the rope hole, one side of the elastic ropes is fixed on the platform under the tense condition.

3. The riding device of claim 1, wherein a caster device assembly is composed of a caster frame, the front axle and two front wheels, the front axle is fixed with the caster frame, the front wheels are equipped separately on the both side of the front axle.

4. The riding device of claim 1, wherein the overrunning clutch assembly can be ratchet clutch.

5. The riding device of claim 1, wherein the overrunning clutch assembly can be roller clutch.

6. The riding device of claim 1, wherein the winding direction of two pulling ropes should be identical, which should be same as the rotating direction of two overrunning clutches assemblies.

7. The riding device of claim 1, wherein the brake device assembly is installed in the front of one rear wheel, including a curved brake pad, a shaft fixed under the platform, a brake lever that passes through the perforated platform, a brake reverse spring, the middle of the brake pad movably attached to the shaft, one side of brake pad is at the back of the shaft, the other side of the brake pad is at the front of the shaft, attached to the brake lever, both sides of the brake reverse spring are fixed separately to the platform and the brake pad.
